(19) United States
(12) Patent Application Publication
(10) Pub. No.: US 2015/0095216 A1
(43) Pub. Date: Apr. 2, 2015

(54) METHODS AND SYSTEMS FOR DETERMINING AND PROVIDING NEGATIVE EVENT NOTIFICATIONS

(71) Applicants: Lauren Van Heerden, Bedford, NH (US); Gunalan Nadarajah, Milton (CA); Orin Del Vecchio, Richmond Hill (CA); Michael D. Cummins, Pickering (CA); Prabaharan Sivashanmugam, Farmington Hills, MI (US)

(72) Inventors: Lauren Van Heerden, Bedford, NH (US); Gunalan Nadarajah, Milton (CA); Orin Del Vecchio, Richmond Hill (CA); Michael D. Cummins, Pickering (CA); Prabaharan Sivashanmugam, Farmington Hills, MI (US)

(73) Assignee: The Toronto-Dominion Bank, Mississauga (CA)

(21) Appl. No.: 14/199,476

(22) Filed: Mar. 6, 2014

Related U.S. Application Data
(60) Provisional application No. 61/884,678, filed on Sep. 30, 2013.

(51) Int. Cl. G06Q 20/40

(52) U.S. Cl. CPC G06Q 20/4016
USPC 705/39

(57) ABSTRACT

The disclosed embodiments include systems and methods for determining and providing notifications of negative events. The disclosed embodiments include, for example, a computer-implemented method for determining negative events. The method may include collecting, by one or more processors, prior financial transaction information associated with a user. The method may also include determining a transaction pattern associated with the user based on the collected financial transaction information. In another aspect, the method may include determining a negative event reflecting a deviation from the transaction pattern associated with the user, the deviation being a nonoccurrence of an expected financial transaction consistent with the transaction pattern. The method may also include providing a notification identifying the deviation.

### CROSS-REFERENCE TO RELATED APPLICATIONS

This application claims the benefit of U.S. Provisional Patent Application No. 61/884,678, filed Sep. 30, 2013, which is incorporated herein by reference.

### BACKGROUND

1. Technical Field

The present disclosure relates to computerized notification systems and methods and, more particularly, to computerized systems and methods for generating a notification reflecting a deviation from a pattern of prior activity.

2. Background Information

The increasing development of computerized financial service transaction processes enable financial and retail institutions to provide many types of services, such as customer transaction monitoring and reporting services. Typically, conventional systems track the activities of a customer for determining future cross selling, marketing, or other opportunities. These systems may employ known prediction algorithms that predict a likelihood of an occurrence of an event based on stored patterns of prior activities and transactions, and provide alerts regarding the occurrence of the predicted event. To combat fraud, for example, such predictive notifications can be used to alert fraud monitors and ensure obstacles are in place to help prevent the occurrence of fraudulent activities. The conventional systems and processes do not, however, provide the ability to detect the absence of a predicted event (e.g., an anticipated financial service transaction) and perform processes to automatically provide an alert and/or take corrective actions based on the type of absent event. Moreover, outside the context of financial transactions, conventional event monitoring systems and processes do not provide the ability to detect the absence of a predicted or anticipated transaction and provide an alert and/or take corrective actions based on the type of absent transaction.

### SUMMARY

The disclosed embodiments include methods and systems for determining when an expected event does not (or will not) occur (e.g., a negative event), and for automatically providing alerts or performing responsive processes based on the determined negative event.

The disclosed embodiments include, for example, a computer-implemented method for determining negative events. The method may include collecting, by one or more processors, prior transaction information associated with a user and determining, by the one or more processors, a transaction pattern based on the collected transaction information. The method may also include determining, by the one or more processors, a negative event reflecting a deviation from the transaction pattern, the deviation being a nonoccurrence of an expected transaction consistent with the transaction pattern. The method may also include providing, by the one or more processors, a negative event notification that identifies the deviation.

The disclosed embodiments also include, for example, a system for determining negative events having a storage device and at least one processor coupled to the storage device. The storage device may store software instructions for controlling the at least one processor when executed by the at least one processor. The at least one processor may be operative with the software instructions and may be configured to collect prior transaction information associated with a user and determine a transaction pattern based on the collected transaction information. The at least one processor may also determine a negative event reflecting a deviation from the transaction pattern, the deviation being a nonoccurrence of an expected transaction consistent with the transaction pattern. The at least one processor may further provide a negative event notification that identifies the deviation.

Consistent with an additional disclosed embodiment, a tangible, non-transitory computer-readable medium stores instructions that, when executed by at least one processor, cause the at least one processor to perform a method for determining negative events. The method may include collecting prior transaction information associated with a user and determining a transaction pattern based on the collected transaction information. The method may also include determining a negative event reflecting a deviation from the transaction pattern, the deviation being a nonoccurrence of an expected transaction consistent with the transaction pattern. The method may further include providing a negative event notification that identifies the deviation.

In another disclosed embodiment, a computer-implemented method for determining negative events may include monitoring, by one or more processors, transactions associated with a user. In another aspect, the method may include determining a transaction pattern derived from the monitored transactions to identify a preemptive action determined to avert an occurrence of a deviation from the transaction pattern, the deviation being a nonoccurrence of an expected transaction that the transaction pattern indicates should have occurred. The method may also include generating one or more electronic instructions to transmit information identifying the preemptive action to a device associated with the user.

The disclosed embodiments also include, for example, a system for determining negative events having a storage device and at least one processor coupled to the storage device. The storage device may store software instructions for controlling the at least one processor when executed by the at least one processor. The at least one processor may be operative with the software instructions and may be configured to monitor transactions associated with a user. In another aspect, the at least one processor may be further configured to determine a transaction pattern derived from the monitored transactions to identify a preemptive action determined to avert an occurrence of a deviation from the transaction pattern, the deviation being a nonoccurrence of an expected transaction that the transaction pattern indicates should have occurred. The at least one processor may be further configured to generate one or more electronic instructions to transmit information identifying the preemptive action to a device associated with the user.

Additional disclosed embodiments relate to, for example, a tangible, non transitory computer-readable medium storing instructions that, when executed by at least one processor, cause the at least one processor to perform a method for determining negative events. The method may include monitoring transactions associated with a user. In another aspect, the method may include determining a transaction pattern derived from the monitored transactions to identify a preemptive action determined to avert an occurrence of a deviation from the transaction pattern, the deviation being a nonoccurrence of an expected transaction that the transaction pattern indicates should have occurred. The method may also include generating one or more electronic instructions to transmit information identifying the preemptive action to a device associated with the user.

It is to be understood that both the foregoing general description and the following detailed description are exemplary and explanatory only, and are not restrictive of the disclosed embodiments as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a diagram of an exemplary computing environment, consistent with disclosed embodiments.

FIG. 2 is a diagram of an exemplary computer system, consistent with disclosed embodiments.

FIG. 3 is a flowchart of an exemplary negative event alert process, consistent with disclosed embodiments.

FIG. 4 is a flowchart of another exemplary negative event alert process, consistent with disclosed embodiments.

FIG. 5 is a flowchart of another exemplary negative event alert process, consistent with disclosed embodiments.

FIGS. 6-8 show block diagrams of exemplary transaction patterns that may be determined and presented, consistent with disclosed embodiments.

FIG. 9 is a flowchart of another exemplary negative event alert process, consistent with disclosed embodiments.

### DETAILED DESCRIPTION

The disclosed embodiments include systems and methods for monitoring events to determine whether a negative event has occurred, or will occur. In certain aspects, a negative event may be associated with the absence of a transaction based on a determined pattern of prior transactions. In certain embodiments, a transaction may reflect activities associated with a financial service account (e.g., financial transactions), reflect activities associated with a person (e.g., activities of a person, locations of a person, etc.), reflect activities associated with a physical item (e.g., smart appliances, devices, packages, goods, products, or other physically tangible items), or reflect activities associated with a nonphysical item (such as an electronic report that is generated and provided by electronic mechanisms, such as electronic mail, webpages, and the like). For example, financial services transactions may include transactions such as financial account payments, fund transfers, bill payments, fund deposits, and the like. A negative event may also be associated with purchase transactions, such as a transaction involving purchase of a product or service.

Other types of events may be affiliated with the negative event aspects of the disclosed embodiments. For example, the disclosed embodiments may include systems and methods for monitoring an individual's activities through electronic monitoring and reporting components that may not be related to purchase or financial service transactions. In other embodiments, negative events may be associated with transactions corresponding to physical items, such as smart appliances, devices, packages, goods, products, or other physically tangible items. In other aspects, the disclosed embodiments may be configured to determine, generate, and provide one or more alerts associated with a detected negative event. For example, the disclosed embodiments may be configured to provide a negative event alert to an individual (e.g., a customer of a financial service provider). In other aspects, the disclosed embodiments may be configured to provide a negative event alert to a group of individuals (e.g., a group of customers of a financial service provider, a family group (e.g., parents and children, etc.). In another aspect, the disclosed embodiments may be configured to provide negative alerts to business entity systems or representatives. Other aspects of the disclosed embodiments are described below and exemplified in the accompanying figures. Although certain embodiments are sometimes described in connection with financial service systems and processes, the disclosed embodiments are not so limited. Aspects of the disclosed embodiments may be configured to handle other types of activities and events that may be unrelated to a transaction involving a good or service or a financial service transaction involving financial service accounts.

As disclosed herein, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, any section headings used herein are for organizational purposes only, and are not to be construed as limiting the subject matter described.

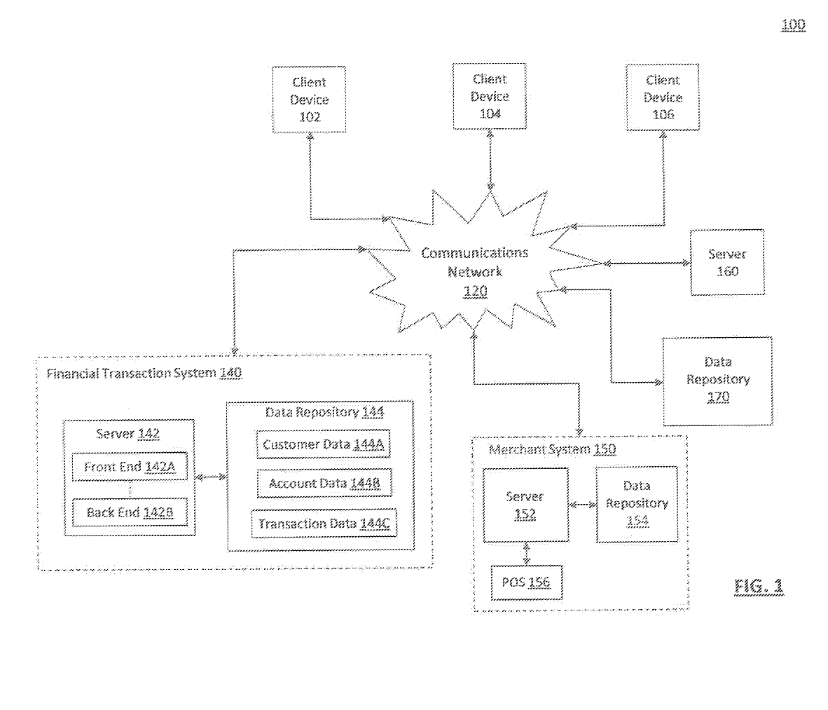

FIG. 1 illustrates an exemplary computing environment 100, consistent with certain disclosed embodiments. In one aspect, system 100 may include a financial transaction system 140, a merchant system 150, a server 160, a data repository 170, and one or more client devices 102, 104, and 106 are interconnected via a communications network 120.

In one embodiment, financial transaction system 140 may be one or more computer systems associated with a financial institution, such as, for example, a commercial bank, an investment bank, a broker-dealer, a provider of a payment instrument and financial service accounts, etc. In some embodiments, a financial service account may be a check, savings, credit, debit, and/or a reward or loyalty account. In one embodiment, a payment instrument may include, but is not limited to, a personal or corporate credit card, a debit card, a prepaid credit or debit card, check instruments. These transactions include, but are not limited to, a transfer of funds between financial accounts (e.g., checking, savings, investment, etc.), a payment of a bill, a purchase or sale of a financial instrument or security, a deposit or withdrawal of funds, or an application for credit.

In certain embodiments, financial transaction system 140 may include a server 142 and a data repository 144. Server 142 may be, for example, a transaction server and may include a front end 142A, and a back end 142B disposed in communication with front end 142A, although the configuration of server 142 is not limited to such configurations. For exemplary purposes only, server 142 may be referred to as a transaction server 142. In one example, front end 142A and back end 142B of transaction server 142 may be incorporated into a single computer, a single server, or any additional or alternate computing device apparent to one or skill in the art. In other embodiments, front end 142A and backend 142B may be distributed computing devices. Further, in one embodiment, front end 142A may be one or more software programs, such as a software application (e.g., a web service) executing on transaction server 142. Similarly, backend 142B may be one or more software programs executing on server 142. However, transaction server 142 is not limited to such configurations, and, in additional embodiments, front end 142A can be executed on any computer or server separate from back end 142B. Transaction server 142 may be configured to execute software instructions to perform one or more processes consistent with the disclosed embodiments. In one embodiment, and client devices 102, 104, and 106 may exchange information and parameters that facilitate an execution of one or more transactions by financial transaction system 140.

Data repository 144 may be one or more data storages configured to store information consistent with the disclosed embodiments. In one aspect, data repository may include customer data 144A, account data 144B, and transaction data 144C. In one aspect, customer data 144A may include one or more data records that uniquely identify one or more customers of a financial institution associated with transaction system 140. By way of example, a customer of the financial institution may access a web page associated with transaction system 140 (e.g., through a web server executed by front end 142A), and may subsequently register for online banking services and provide data, which may be linked to the customer and stored within customer data 144A.

In certain aspects, customer data 144A may include personal information associated with a customer (e.g., a customer name, a home address, and a date of birth), government-issued identifiers (e.g., drivers license numbers and Social Security numbers), employment information (e.g., employer name and address), and contact information (e.g., email addresses, home numbers, work numbers, and mobile numbers). Customer data 144A may also include one or authentication credentials associated with registered customers of the financial institution. For example, the authentication credentials may include, but are not limited to, a user name, a user-specified password, a system-generated password, or an alphanumeric identification number (e.g., a PIN number) specified by the user or assigned by financial transaction system 140. Other types of customer information may be stored and used by the disclosed embodiments.

Additionally or alternatively, customer data 144A may include information facilitating enhanced authentication techniques. For example, customer data 144A may store information identifying a security question associated with the customer (e.g., “What is your mother's maiden name?”) and the customer's registered answer to that security question. Customer data 144A may also include information identifying a particular security image or avatar selected by the user and displayed by the user during the authentication process.

Further, in one embodiment, customer data 144A may include user device identification information that identifies one or more devices registered to the user. In one embodiment, the user may provide the user device identification information (e.g., a mobile telephone number provided by the user when registering for online banking services), or alternatively, transaction server 142 may be configured to execute processes that automatically collect user device identification information (e.g., collecting an Internet Protocol (IP) address associated with the customer's smartphone).

Customer data 144A may also include data that enables transaction server 142 to target content to one or more users (e.g., customers of financial institution associated with financial transaction system 140), or alternatively, to identify a peer group of users (e.g., customers) having interests similar to those of a particular user (e.g., a customer). For example, such data may include, but is not limited to, demographic data associated with the group of users (e.g., age group, educational level, income level), social networking data (e.g., “handles” and links to one or more social networking sites), profile data indicating specific interests, and any additional or alternate data that appropriate to the customers and transaction server 142.

In certain aspects, account data 144B may include account identification information identifying one or more accounts of customers of the financial institution associated with transaction system 140. In one embodiment, account identification information may include financial service account information, such as, for example, a checking account, a savings account, a revolving credit line, a account linked to a credit or debit card, a brokerage account, and any additional or alternate account provided or supported by the financial institution. In other embodiments, account data 144B may include information identifying investment portfolios held by one or more customers of the financial institution (e.g., positions in one or more securities held by the customers). In other aspects, account data 144B may include account information associated with non-financial service accounts, such as membership accounts for certain services or activities (e.g., gym membership, prescription drug information, library card, employment identification, student account information, etc.)

In such embodiments, information within account data 144B may identify, for a single customer, one or more accounts associated with the customer and account data corresponding to the accounts (e.g., an account number, expiration date information, card security codes, account balance information, and/or credit limit information).

Transaction data 144C may include information identifying one or more transactions that involve one or more customers of the financial institution associated with financial transaction system 140, and additionally or alternatively, one or more accounts of the one or more customers of the financial institution. In one embodiment, such transactions may include, but are not limited to, purchase transactions (e.g., purchases of goods and/or services from electronic or physical retailers), financial service transactions (e.g., fund transfers (e.g., between accounts), bill payment transactions (e.g., electronic bill payment transactions), financial instrument or security purchases or sales, a deposit or withdrawal of funds, or an application for credit from the financial institution or other entity.

For example, financial transaction system 140 may be configured to execute software instructions that provide an online financial service portal that enables a customer to access a web page of the financial institution to perform financial service type transactions. For instance, financial transaction system 140 may provide an online banking portal that enables a customer to transfer funds between a first customer account to a second customer account, to schedule automatic bill payment services (e.g., select an amount and periodic payment date for making payments to an identified payee from the customer's selected financial account), and other known types of online financial service processes. For instance, financial transaction server 140 may generate a data record within transaction data 144C that corresponds to the particular service initiated by the customer, such as an initiated transfer of funds, and may populate the data record with information associated with the initiated transaction. As an example, transaction information for a funds transfer may include, but is not limited to, an unique identifier associated with the fund transfer transaction, a timestamp of the transaction, and transaction parameter information (e.g., a source account, a target account, a transaction date, and an amount of transfer).

Merchant system 150 may be one or more computer systems associated with a business entity that provides products and/or services. In one example, merchant system 150 may be associated with a retailer having one or more physical retail locations disposed within a geographic area (i.e., a “physical retailer”). Merchant system 150 may be a retailer that provides electronic or e-commerce type retail services. In one example, merchant system 150 may be an electronic or an e-commerce retailer that interacts with consumers through corresponding web interfaces or retailer-specific application programs (e.g., mobile “apps”). In one embodiment, one or more client devices 102, 104, and 106 can exchange information with merchant system 150 to purchase one or more goods and/or services using various payment instruments, and merchant system 150 exchanges information with financial transaction system 140 to obtain authorization for such purchase instruments, e.g., using a point-of-sale module described below.

Merchant system 150 may include, in one example, a merchant server 152, a data repository 154, and point-of-sale (POS) module 156. Although not depicted in FIG. 1, merchant server 152 may include a front end and a back end disposed in communication with the front end. In an embodiment, the front and back ends may be incorporated into a hardware unit, for example, a single computer, a single server, or any additional or alternate computing device apparent to one or skill in the art. In other embodiments, the front end may be a software application, such as a web service, executing on merchant server 152. However, merchant server 152 is not limited to such configurations, and, in additional embodiments, the front end may be executed on any computer or server separate from the back end.

Data repository 154 may be one or more storage devices that store information consistent with the disclosed embodiments. In one aspect, data repository 154 may store customer data that uniquely identifies and profiles one or more customers of the merchant associated with merchant system 150, and transaction data identifying one or more purchase transactions involving one or more customers of the merchant. Further, in such embodiments, data repository 164 also includes elements of electronic content that may be delivered to customers of the merchant, including but not limited to, images and corresponding text describing goods and services sold by the merchant, one or more advertisements that could be delivered to the customers, and one or more rewards that could be provided to the customer.

In one embodiment, POS 156 may be one or more point-of-sale devices configured to perform known point-of-sale processes. POS 156 may be disposed at a physical location in a merchant location associated with merchant system 150, such as a location where a customer may provide payment for goods and/or services (e.g., at a cash register at the merchant). The disclosed embodiments are not limited to such physical POS modules, and in additional embodiments, POS module 156 may be a software module executed by merchant server 152.

Client devices 102, 104, and 106 may each reflect a computing device associated with a user (e.g., a customer of the merchant and/or the financial institution disclosed above). In certain aspects, client devices 102, 104, and 106 can include, but are not limited to, a personal computer, a laptop computer, a tablet computer, a notebook computer, a handheld computer, a personal digital assistant, a portable navigation device, a mobile phone, a smart phone, a set top box, a third party portals, an optical disk player (e.g., a DVD player), a digital video recorder (DVR), and any additional or alternate computing device operable to transmit and receive data across network 120.

Further, although computing environment 100 is illustrated in FIG. 1 with three client devices 102, 104, and 106 in communication with transaction system 140, persons of ordinary skill in the art will recognize that environment 100 may include any number of number of mobile or stationary client devices, and any additional number of computers, systems, or servers without departing from the spirit or scope of the disclosed embodiments. Further, although computing environment 100 is illustrated in FIG. 1 with a single merchant system 150, a single transaction system 140, a single server 160, and a single external data repository 170, persons of ordinary skill in the art will recognize that environment 100 may include any number of additional number of merchant and financial systems, any number of additional number of servers and data repositories, and any additional number of computers, systems, servers, or server farms without departing from the spirit or scope of the disclosed embodiments.

Communications network 120 may represent any form or medium of digital data communication. Examples of communication network 120 include a local area network (“LAN”), a wireless LAN, a RF network, a Near Field Communication network, e.g., a “WiFi” network, a wireless Metropolitan Area Network (MAN) that connects multiple wireless LANs, and a wide area network (“VAN”), e.g., the Internet. Consistent with embodiments of the present disclosure, network 120 can include the Internet and include any publicly accessible network or networks interconnected via one or more communication protocols, including, but not limited to, hypertext transfer protocol (HTTP) and transmission control protocol/internet protocol (TCP/IP). Moreover, communications network 120 may also include one or more mobile device networks, such as a GSM network or a PCS network, that allow client devices, such as client device 102, to send and receive data via applicable communications protocols, including those described above.

In one embodiment, one or more of transaction server 142 and merchant server 152 may include a general purpose computer (e.g., a personal computer, network computer, server, or mainframe computer) having one or more processors that may be selectively activated or reconfigured by a computer program. In additional embodiments, one or more of transaction server 142 and merchant server 152 may be incorporated as corresponding nodes in a distributed network, and additionally or alternatively, as corresponding networked servers in a cloud-computing environment. Furthermore, transaction server 142 and merchant server 152 may communicate via network 120 with one or more additional servers (not shown), which facilitate the distribution of processes for parallel execution by the additional servers. In certain aspects, transaction server 142 and/or merchant server 152 may execute software instructions that perform one or more processes consistent with the disclosed embodiments.

Server 160 may be a computing device that provides information to one or more other components of computing environment 100. In one embodiment, server 160 may include a general purpose computer (e.g., a personal computer, network computer, server, or mainframe computer) having one or more processors that may be selectively activated or reconfigured by a computer program. In one aspect, server 160 may be configured to provide one or more websites associated with an advertiser and/or content provider network. Further, upon request from a client device (e.g., client device 102), server 160 may be configured to provide information associated with a requested web page over communications network 120 to client device 102, which may render the received information and present the web page to a customer. Additionally, server 160 may be incorporated as a corresponding node in a distributed network, and additionally or alternatively, as a corresponding networked server in a cloud-computing environment. Furthermore, server 160 may communicate via network 120 with one or more additional servers (not shown), which may facilitate the distribution of processes for parallel execution by the additional servers.

Data repository 170 may be one or more storages that store information provided by or used by one or more components of computing environment 100. In one aspect, data repository may be incorporated into a single hardware unit, for example, a single computer or a single server. In such an embodiment, data repository 170 may be include one or more storage mediums or storage devices. However, data repository 170 is not limited to such configurations, and, in additional embodiments, data repository 170 may reside on any additional or alternate computer or server accessible to transaction server 142, merchant server 152, and client devices 102, 104, and 106 over network 120.

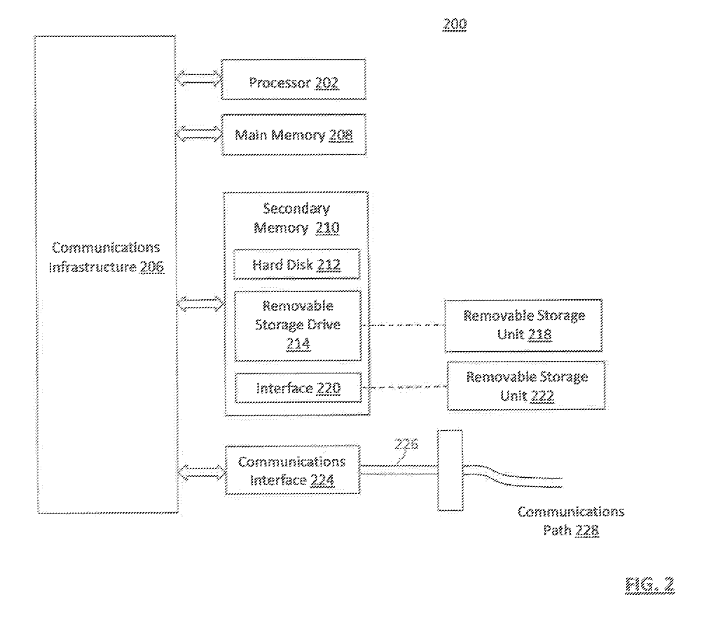

FIG. 2 is an exemplary computer system 200 with which embodiments consistent with the present disclosure may be implemented. In one aspect, computer system 200 may reflect the computer systems associated with server 142, server 152, server 160, client devices 102, 104, and/or 106. In certain embodiments, computer system 200 may include one or more processors, such as processor 202. Processor 202 may be connected to a communication infrastructure 206, such as a bus or communications network, e.g., network 120 of FIG. 1.

Computer system 200 may also include a main memory 208, for example, random access memory (RAM), and may include a secondary memory 210. Secondary memory 210 may include, for example, a hard disk drive 212 and/or a removable storage drive 214, representing a magnetic tape drive, an optical disk drive, CD/DVD drive, etc. The removable storage drive 214 reads from and/or writes to a removable storage unit 218 in a well-known manner. Removable storage unit 218 may represent a magnetic tape, optical disk, or other storage medium that is read by and written to by removable storage drive 214. As will be appreciated, the removable storage unit 218 can represent a computer-readable medium having stored therein computer programs, sets of instructions, code, or data to be executed by processor 202.

In alternate embodiments, secondary memory 210 may include other means for allowing computer programs or other program instructions to be loaded into computer system 200. Such means may include, for example, a removable storage unit 222 and an interface 220. An example of such means may include a removable memory chip (e.g., EPROM, RAM, ROM, DRAM, EEPROM, flash memory devices, or other volatile or non-volatile memory devices) and associated socket, or other removable storage units 222 and interfaces 220, which allow instructions and data to be transferred from the removable storage unit 222 to computer system 200.

Computer system 200 may also include one or more communications interfaces, such as communications interface 224. Communications interface 224 allows software and data to be transferred between computer system 200 and external devices. Examples of communications interface 224 may include a modem, a network interface (e.g., an Ethernet card), a communications port, a PCMCIA slot and card, etc. Software and data may be transferred via communications interface 224 in the form of signals 226, which may be electronic, electromagnetic, optical or other signals capable of being received by communications interface 224. These signals 226 are provided to communications interface 224 via a communications path (i.e., channel 228). Channel 228 carries signals 226 and may be implemented using wire, cable, fiber optics, RF link, and/or other communications channels. In a disclosed embodiment, signals 226 comprise data packets sent to processor 202. Information representing processed packets can also be sent in the form of signals 226 from processor 202 through communications path 228.

In certain embodiments in connection with FIG. 2, the terms “storage device” and “storage medium” may refer to particular devices including, but not limited to, main memory 208, secondary memory 210, a hard disk installed in hard disk drive 212, and removable storage units 218 and 222. Further, the term “computer-readable medium” may refer to devices including, but not limited to, a hard disk installed in hard disk drive 212, any combination of main memory 208 and secondary memory 210, and removable storage units 218 and 222, which respectively provide computer programs and/or sets of instructions to processor 202 of computer system 200. Such computer programs and sets of instructions can be stored within one or more computer-readable media. Additionally or alternatively, computer programs and sets of instructions may also be received via communications interface 224 and stored on the one or more computer-readable media.

Such computer programs and instructions, when executed by processor 202, enable processor 202 to perform one or more processes consistent with the disclosed embodiments. Examples of program instructions include, for example, machine code, such as code produced by a compiler, and files containing a high-level code that can be executed by processor 202 using an interpreter.

Furthermore, the computer-implemented methods described herein can be implemented on a single processor of a computer system, such as processor 202 of system 200. However, in additional embodiments, these computer-implemented methods may be implemented using one or more processors within a single computer system, and additionally or alternatively, these computer-implemented methods may be implemented on one or more processors within separate computer systems linked via a network.

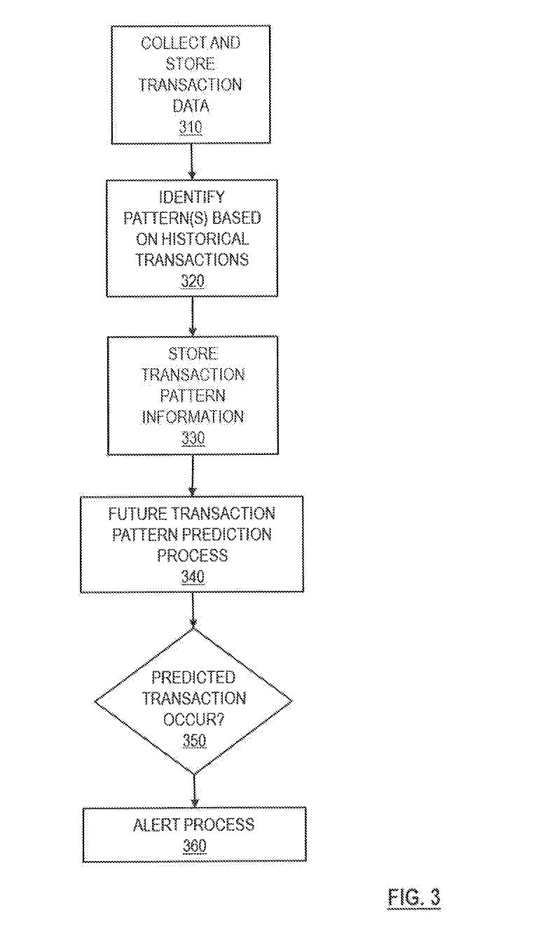

FIG. 3 illustrates a flowchart of an exemplary negative event monitoring and alert process 300 consistent with certain disclosed embodiments. In one embodiment, financial transaction system 140 may collect and store transaction data associated with a user (e.g., a customer of the financial institution associated with financial transaction system 140) (step 310). For instance, transaction server 142 may execute software instructions to perform financial transactions initiated by the user through a client device (e.g., client device 102). As an example, the financial transaction may include a bill payment transaction that is configured by the user through an online banking portal provided by transaction server 142 (or other computing device). For instance, over a period of time (e.g., monthly, bimonthly, quarterly, etc.), the user may access the online banking portal to make an electronic bill payment of $100.00 to a designated payee P1 on or around the 15^{th} of every month using a first financial service account identified by the user. Other types of financial transactions may be performed and tracked by the disclosed embodiments. Financial transaction system 140 may be configured to store information reflecting the bill payment transaction (or any other type of transaction), such as the amount, the payee, timestamp information, and the like. In one embodiment, financial transaction system 140 may assign a unique transaction identifier for the periodic bill payment transaction.

Financial transaction system 140 may also be configured to execute software instructions that automatically identify pattern(s) based on historical transactions for the user (step 320). In one aspect, financial transaction system 140 may analyze the stored transaction data collected in step 310 using known predictive algorithms that identify one or more patterns. For example, financial transaction system 140 may analyze a determined sample of history transaction data collected and stored by server 142 and data repository 144, such as the past six months of periodic bill payments, which may be identified using the unique transaction identifier for the periodic bill payment transaction exemplified above. Based on the analysis, financial transaction system 140 may identify a pattern that the user makes the $100.00 payment to payee P1 on or near the 15^{th} of every month for the past six months.

Financial transaction system 140 may store the transaction pattern information identified in step 320 (step 330). In another aspect, financial transaction system 140 may execute software instructions that perform a future transaction pattern prediction process (step 340). For instance, financial transaction system 140 may execute one or more algorithms that predict that the user will make another electronic payment to payee P1 on or near the 15^{th} of the next month using the same financial service account that was used to make the previous online bill payments. Financial transaction system 140 may be configured to generate expected transaction pattern information for the predicted bill payment and store the information in memory (e.g., data repository 144).

In certain embodiments, financial transaction system 40 may be configured to execute a negative event detection process that determines whether the user made the predicted electronic payment on or near the 15^{th} of the next month when that time arrives (step 350). If so (step 350; Yes), financial transaction system 140 may record the transaction information for the electronic bill payment (step 310). If not (step 350; No), financial transaction system 140 may perform an alert process that automatically generates an alert message for the user to inform the user that the expected bill payment was not made (step 360). In one aspect, the alert process may include generating an alert message based on preconfigured alert parameters set up by the user through the financial service portal and the user's client device (e.g., device 102). Based on the alert parameters, financial transaction system 140 may generate and provide the alert message to the user's client device (e.g., email, text message, automated voice message, etc.) to inform the user that an expected bill payment (e.g., a transaction event) did not occur.

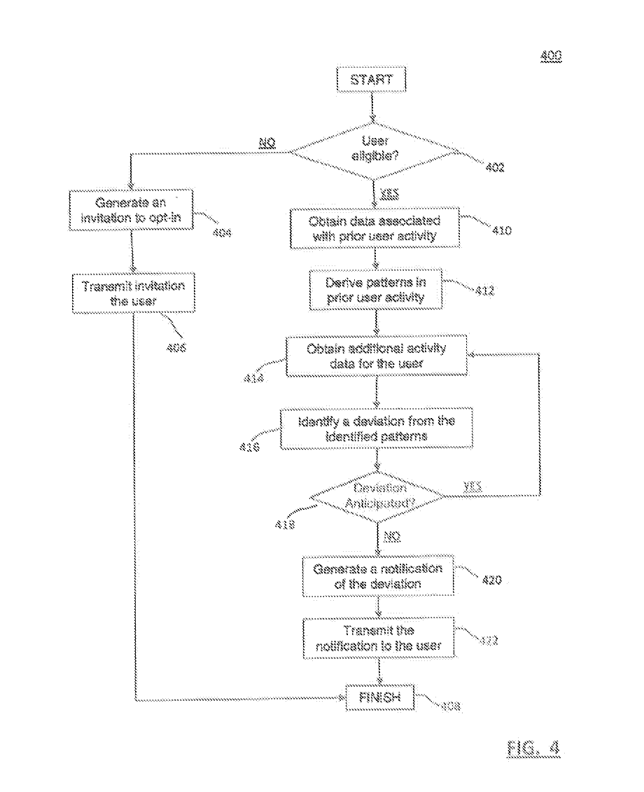

The disclosed embodiments may be configured to execute software instructions to perform different types of negative event alert processes, based on the type of event, transaction, and/or other characteristics associated with the behavior or activity of a user or an account associated with the user. For example, FIG. 4 illustrates a flowchart of exemplary method 400 for notifying users of deviations from patterns of prior activity, consistent with certain embodiments of the present disclosure. In one embodiment, a server (or other computing device or system) associated with a financial institution (e.g., transaction server 142 of FIG. 1) may be configured to obtain data identifying one or more prior activities of a user, to identify a pattern within the obtained data, and to provide a notification to the user upon identification of activities that deviate from the identified pattern. For example, these activities may include, but are not limited to, purchases of goods or services by the user, financial services transactions requested by or executed by the user, and user-specified and user-configured events.

In one embodiment, transaction server 142 may determine in step 402 whether the user is eligible to receive notifications of deviations (e.g., the user may have “opted-in” to receive notifications from the financial institution or financial transaction system 140). For example, transaction server 142 may access data associated with the user (e.g., customer data 144A of FIG. 1), and may determine, based on the obtained customer data, whether the user elected to receive notifications regarding negative event(s).

If transaction server 142 finds the user ineligible to receive notifications from the financial institution (step 402; No), transaction server 142 may generate a message that invites the user to “opt-in” to the notification program provided by the financial institution (e.g., step 404). In step 406, transaction server 142 may execute software processes to transmit the generated message to a client device of the user (e.g., client device 102 of FIG. 1) using one or more of the communications protocols described herein. Method 400 may then complete in step 408.

If, however, transaction server 142 determines that the user is eligible to receive notifications from the financial institution (step 402; Yes), transaction server 142 may obtain data identifying one or more prior activities of the user in step 410. In one embodiment, client devices 102, 104, and 106 may provide the data identifying the one or more prior user activities to transaction server 142 over communication network 120 from client devices 102, 104, and 106. In another embodiment, merchant server 152 may be configured to collect and provide the data identifying the one or more prior user activities to transaction server 142 over network 120. In another embodiment, financial transaction system 140 may be configured to obtain the data identifying the one or more prior user activities from one or more social network sites, such as FaceBook™, Twitter™, Instagram™, and etc. In one aspect, server 160 may reflect a social network server that provides such information to transaction server 142. In yet another embodiment, financial transaction system 140 can obtain data from one or more groups of users. For example, activity data may be associated with individuals of a group, such as a family group (e.g., mother, father, children, or other relatives), a friend group (e.g., individuals who are acquainted and who voluntarily agree to be grouped together for purposes of the negative event process of the disclosed embodiments), a business group (e.g., coworkers, division representatives, regional office representatives, etc.), and any other type of group of individuals.

In an embodiment, the data obtained by transaction server 142 in step 410 may identify one or more prior purchases of goods and services by the user. For example, the user may purchase coffee every weekday at 10:00 a.m. from a coffee shop, and a point-of-sale terminal (e.g., POS 156) at the coffee shop may transmit data associated with the purchase to transaction server 142 across network 120 (e.g., via merchant server 152 or through an independent connection to network 120). In some embodiments, transaction server 142 may execute software processes to store the received purchase data in a corresponding portion of a data repository (e.g., transaction data 144C of data repository 144).

Data obtained by transaction server 142 in step 410 may also identify one or more prior financial services transactions executed by the user and associated with an account of the user at a corresponding financial institution (e.g., the financial institution associated with transaction server 142). By way of example, the financial services transactions include, but are not limited to, an electronic fund transfer (EFT) transaction between accounts associated with the user, a deposit of funds into an account of the user, a withdrawal of funds from an account of the user, an online bill payment transaction, and a purchase or sale of securities to create an investment portfolio or to modify a composition of an existing investment portfolio of the user.

In some embodiments, the data identifying a prior financial services transaction may include, but is not limited to, information identifying a corresponding transaction type, information identifying one or more terms or parameters of the prior financial services transaction, and information identifying a mechanism by which the user requested an execution of the prior financial services transaction. For example, a user may submit a printed payroll check to an automated teller machine (ATM) associated with the financial institution, and the ATM may transmit a request to deposit the payroll check into the user's checking account across network 120 to transaction server 142. Upon receipt of the request, and in addition to electronically depositing the payroll check, transaction server 142 may execute software processes to store the received transaction data (e.g., a transaction type, a corresponding deposit date, an amount of deposit, information identifying the ATM, and information associated with the payroll check, such as a corresponding drawee and/or an endorsee) in a portion of a data repository (e.g., transaction data 1440).

Data obtained in step 410 may also be associated with various events caused, scheduled, or configured by the user. For example, the user may configure a programmable home appliance to activate automatically each day at specific times (e.g., a coffee maker is scheduled to brew coffee at 7:00 a.m. each day, or an oven is scheduled to preheat at 6:00 p.m. each day). Further, by way of example, the obtained data may correspond to an activation of a home, business, or automobile security system. Additionally or alternatively, transaction server 142 may also obtain data in step 410 indicative of one of more user-configured events, including, but not limited to, appointments, out of office notices, and do not notify periods. In such embodiments, transaction server 142 may be associated with non-financial transaction system, such as a negative event monitoring system (not shown) that is configured consistent with the system shown in FIG. 2. Further, in such embodiments, the programmable home appliance, security systems, etc. may be configured to communicate when an occurrence of the programmed event to transaction server 142 over network 120 to provide notification of performance of the event.

Further, in additional embodiments, the data obtained in step 410 may identify any financial transaction and/or event that is “trackable” by transaction server 142, merchant server 152, or any component thereof. These trackable financial transactions and/or events include, but are not limited to, purchasing travel tickets, creating a calendar event on client device 102, creating a schedule for timers on client device 102, receiving and filing a prescription, coupon expiration dates, etc.

As described above, the data obtained by transaction server 142 in step 410 may identify prior purchases made by the user, prior financial services transactions executed by user, and prior events associated with the user. In some embodiments, the obtained data may indicate sequential relationships that exist between the prior purchases, financial services transactions, and events. For example, the obtained data may indicate that the user regularly purchases goods from a particular grocery store before purchasing fuel at a particular fuel filling station, or further, that the user regularly executes an electronic funds transfer (EFT) transaction subsequent to depositing a payroll check into a checking account provided by a financial institution.

In additional embodiments, the obtained data may indicate a periodic or repetitive character of the prior purchases, financial services transactions, and events. For example, the obtained data may indicate that the user purchases a specific type of coffee (e.g., a large iced coffee) in the amount of $2.50 every weekday at or around 10:00 a.m. from a specific coffee shop (e.g., Starbucks™). Additionally or alternatively, the obtained data may indicate that the user deposits a payroll check drawn on a specific bank every Friday at or around 6:00 p.m. using a mobile banking application executed by a corresponding client device (e.g., client device 102). The disclosed embodiments may be configured to use obtained data that reflects different types of periodic or repetitive events or transactions. The examples identified above are not limiting to the disclosed embodiments.

Referring back to FIG. 4, in step 412, transaction server 142 may process the obtained data to identify the sequential relationships and repetitive characteristics, and to derive patterns associated with the user's prior purchases, financial services transactions, and events. In one embodiment, and as described herein, the derived patterns may indicate a sequential relationship between corresponding purchases, financial services transactions, and events (e.g., the user may purchase fuel from a specific fuel filling stations after purchasing goods from a specific grocery store).

Further, in additional embodiments, the derived patterns may correspond to repetitions of a specific purchase, financial services transaction, or event at specific intervals (e.g., the purchase of a large iced coffee from Starbucks™ each workday at or around 10:00 a.m., the deposit of a payroll check using a mobile banking application every Friday at or around 6:00 p.m., and the user's configuration of a coffee maker to brew coffee at or around 8:00 a.m. every Sunday). In certain embodiments, the time frames for specific events that may be tracked by the disclosed embodiments may be associated with time ranges (e.g., between 6:00 am and 9:00 am, etc.). The disclosed embodiments are, however, not limited to such exemplary patterns of prior user activity, and in further embodiments, transaction server 142 may identify any additional pattern of user activity in step 412 that is appropriate to the obtained data without departing from the spirit or scope of the disclosed embodiments.

Upon derivation of the patterns in step 412, transaction server 142 may receive additional data associated with the user's current activities in step 414 (e.g., the purchases of goods and services, executions of financial services transactions, and a performance of other user-requested or user-configured events). As described above, the additional data can be communicated over communication network 120 from client devices 102, 104, and 106, from merchant system 150, and/or from various servers (e.g., server 160 of FIG. 1) associated with social network sites (e.g., FaceBook™, Twitter™, Instagram™, and etc.), and may be associated with single activities or with batches of activities. In some embodiments, transaction server 142 may execute software processes to store the received additional data in a corresponding portion of a data repository (e.g., transaction data 144C), as well as to update the derived patterns upon receipt of the additional data, when the received additional data exceeds a threshold amount of data, and additionally or alternatively, at periodic or predetermined intervals.

In step 416, transaction server 142 may monitor the additional data to identify deviations from one or more of the derived patterns. In some embodiments, transaction server 142 may process the derived patterns to identify one or more expected events (e.g., a specific good or service purchased by the user at a particular time and from a particular retailer, and a particular financial services transaction executed by the user at a specific time and date using a specific platform), and may determine an occurrence of a deviation from one or the derived patterns when a corresponding one of the expected events fails to occur.

By way of example, transaction server 142 may derive a pattern in step 412 corresponding to the user's purchase of an iced coffee for $2.50 from a specific coffee shop each workday at or around 10:00 a.m. In step 414, transaction server 142 receives data from a server of the retailer (e.g., merchant server 152) indicating the user's purchase of the iced coffee in the amount of 2.50 at or around 10:00 am, on Tuesday morning. Thus, as the expected purchase occurred in accordance with the derived pattern, transaction server 142 may determine a negative event occurs when the processes identifies a deviation from the identified pattern(s) in step 416.

In one embodiment, transaction server 142 may receive additional transaction data from merchant server 152 in step 414 corresponding to purchases of coffee on Wednesday morning. In one example, transaction server 142 may process the additional transaction data and determine that the user failed to purchase the expected iced coffee for $2.50 at or around 10:00 a.m. on Wednesday, and transaction server 142 may determine in step 416 that the absence of the expected purchase constitutes a deviation from the derived pattern (e.g., identifies a negative event).

In additional embodiments, transaction server 142 may identify a deviation from a pattern of user activity (e.g., purchases, financial services transactions, user-specified or user-configured events, etc.) when an expected event fails to occur within a threshold time period before or after a time associated with the expected event (i.e., an expected time). By way of example, as described above, transaction server 142 may expect a purchase by the user of an iced coffee in the amount of $2.50 at or around 10:00 a.m. on each workday. In such an embodiment, transaction server 142 may determine that a deviation from the derived pattern occurs when the disclosed embodiment determine that the user fails to make the expected purchase in a temporal window ranging from 9:30 a.m. to 10:30 a.m. (i.e., within thirty minutes of the expected time of 10:00 a.m.).

Further, in additional embodiments, transaction server 142 may be configured to execute software instructions that apply one or more threshold ranges to any additional or alternate characteristics or parameters of the expected event when identifying an occurrence of the deviation in step 416. For example, transaction server 142 may expect a purchase by the user of an iced coffee in the amount of $2.50 at or around 10:00 a.m. on each workday. In step 416, transaction server 142 may identify a deviation from the expected pattern (e.g., a negative event) when the server determines that the user fails to purchase an iced coffee ranging from $1.50 to $3.99 at or around 10:00 am on a workday. As another example, transaction server 142 may identify a deviation from the expected pattern (e.g., a negative event) when transaction server 142 determines that the user fans to purchase an iced coffee ranging from $1.50 to $3.99 during a temporal window ranging from 9:30 a.m. to 10:30 a.m. on a weekday. In another example, transaction server 142 may identify a deviation from the expected pattern (e.g., a negative event) when the server determines that the user fails to purchase of any product from the coffee shop ranging in price from $1.50 to $3.99 during a temporal window ranging from 9:30 a.m. to 10:30 a.m. on a weekday. The disclosed embodiments may be configured to detect negative events based on a combination of one or more configured deviations from an expected pattern.

Through these embodiments, transaction server 142 may account for minor variations in the user's patterns of activity based on one or more user preferences or seasonal occurrences. For example, transaction server 142 may be configured to track calendar information in connection with the pattern data to account for a season variation in the user's preferences (e.g., a purchase of an extra-large iced coffee on hot days, or a purchase of pumpkin-flavored hot coffee on a cool day in October).

Referring back to FIG. 4, transaction server 142 may determine whether the identified deviation corresponds to an anticipated deviation (e.g., in step 418). In some embodiments, the identified deviation may represent an “anticipated” deviation from the user's pattern of activities. By way of example, an anticipated deviation may reflect a deviation that transaction server 142 expects based on other information associated with the user. For instance, transaction server 142 may be configured to execute software instructions that receive calendar, meeting, travel itinerary information, etc., from the user's client device (e.g., client device 102). In certain aspects, transaction server 102 may be configured to periodically or dynamically request such information from the client device. In turn, the client device may execute software instructions that provide the information in response to the request. Alternatively, or in addition to, the user's client device (e.g., client device 102) may be configured to execute software instructions that automatically upload calendar, meeting, travel itinerary information, etc., associated with the user from applications executing on the client device (e.g., meeting event information on the user's calendar application that identifies travel to a different city, information identifying a holiday (e.g., a U.S. Federal holiday or a U.S. state holiday) or other scheduled work closure on the day of the expected purchase, etc.). Based on the other user information, transaction server 142 may be configured to flag an expected pattern event as an anticipated deviation, which may direct transaction server 142 to bypass any notification processes for such a deviation.

In one embodiment, transaction server 142 may access information identifying one or more prior transactions of the user (e.g., transaction data 144C of FIG. 1) to identify specific purchases (e.g., airline tickets, train tickets, hotel reservations) that indicate an anticipated characteristic of a deviation. Additionally or alternatively, transaction server 142 may obtain information identifying one or more appointments scheduled by the user (e.g., user calendar data obtained from customer data 144A, or alternatively, from one or more of client devices 102, 104, and 106), and may determine whether a scheduled appointment accounts for the identified deviation. The disclosed embodiments are, however, not limited to such exemplary indicia of anticipated deviations, and in additional embodiments, transaction server 142 may identify an anticipated deviation from the user's pattern of activity based on any additional or alternate information obtained from a data repository accessible to transaction server 142 (e.g., database 144 or data repository 170), from one of client devices 102, 104, and 106, or from merchant system 150.

In an additional embodiment, transaction server 142 may determine in step 418 whether the identified deviation may be explained by a comparable purchase, financial services transaction, and/or event that differs from, but is similar to, the expected purchase, financial services transaction, or event. For example, transaction server 142 may execute software instructions that predict and expect a purchase by the user of an iced coffee in the amount of $2.50 from a particular coffee shop at or around 10:00 a.m. on Wednesday, and may identify a deviation from the user's activity pattern when that expected purchase fails to occur. In response to the identified deviation, transaction server 142 may access transaction data associated with the user (e.g., transaction data 144A), may determine that the user purchased some good(s) or service(s) (e.g., a comparable iced coffee for $2.50) at another business (e.g., a competitor coffee shop) at or around 10:00 a.m. on Wednesday. Based on the identified comparable purchase, transaction server 142 may determine that the identified deviation as “anticipated” in step 418.

Referring back to FIG. 4, if transaction server 142 determines in step 418 that the identified deviation is not anticipated, transaction server 142 may generate a message notifying the user of the identified deviation (e.g., in step 420). In step 422, transaction server 142 may execute software processes to transmit the notification message to the user at client device 102 using any of the communications protocols disclosed herein. In some embodiments, transaction server 142 may access data associated with the user (e.g., customer data 144A) to identify a preferred mode of communication with client device 102 (e.g., contact via email or contact via SMS or MMS text message), and select a communications protocol corresponding to the user's preferred mode of communication. Exemplary method 400 then continues to step 408.

Referring back to step 418, if transaction server 142 determines that the identified deviation corresponds to an anticipated deviation (e.g., a travel plan or prior appointment of the user accounts for the deviation), the exemplary method 400 may continue to step 414. Transaction server 142 may be configured to monitor additional data describing one or more purchases, financial services transactions, or events associated with the user, consistent with the processes described above.

In one embodiment, the notification message transmitted to the user's client device (e.g., client device 102) may be configured as a reminder to the user to perform an activity associated with the identified deviation. For instance, as exemplified above, transaction server 142 may identify a deviation corresponding to an absence of a purchase of iced coffee by the user, and the notification message transmitted to the user in step 422 may include information that reminds the user to purchase the iced coffee (e.g., an email or text message that asks the user “Did you forget your iced coffee today?”). Alternatively, transaction server 142 may identify that the user failed to execute an expected transfer of funds from a checking account to a corresponding credit card account of the financial institution, and the notification message may remind the user execute the expected transaction prior to a payment deadline associated with the credit card (e.g., the notification message may be an email or text message that reminds the user to execute the funds transfer prior to the deadline).

In some embodiments, transaction server 142 may generate the notification message (e.g., in step 420) and transmit the notification message to the user (e.g., in step 422) upon identification of the deviation. Alternatively, transaction server 142 may generate the notification message upon expiration of a threshold period after a time associated with the expected purchase, financial services transaction, and event (e.g., one minute, fifteen minutes, thirty minutes, one hour, and any additional or alternate time). In one aspect, the threshold period may be established by the user and/or programmatically determined by transaction server 142.

In addition to, or as an alternative to, notifying the user of the identified deviation, the notification message may include information reflecting a coupon, discount, or other reward associated with the expected purchase, financial services transaction, or event. For example, the notification message generated by transaction server 142 in step 422 may remind the user to purchase an iced coffee, and further, may provide the user with a coupon offering a discount on the purchase of the iced coffee, and additionally or alternatively, a discount on any additional purchase from the coffee shop. Thus, in certain aspects of the disclosed embodiments, the generated notification message serve both to notify the user to the deviation and further, provide an incentive for the user to complete the expected purchase, financial services transaction, or event.

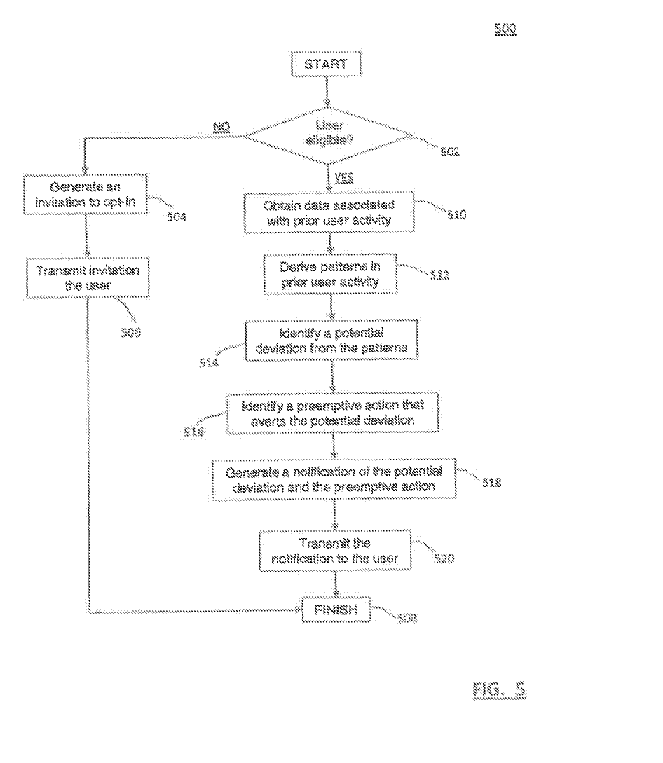

In certain embodiments, transaction server 142 may identify a deviation from a pattern of a user's prior purchases, financial services transactions, and user-configured or user-specified events, and subsequently notifies the user of the deviation. The disclosed embodiments are, however, not limited to techniques that notify the user of a deviation after that deviation occurs. In additional embodiments, described below in reference to FIG. 5, transaction server 142 may identify an potential deviation from a pattern of a user's prior purchases, financial services transactions, and user-configured or user-specified events, and may provide, to the user, information identifying a preemptive action that would prevent an occurrence of the potential deviation.

FIG. 5 illustrates a flowchart of exemplary method 500 for notifying one or more users of one or more preemptive actions that may avert deviations from patterns of prior activity, consistent with embodiments of the present disclosure. In one embodiment, method 500 provides functionality to enable a server associated with a financial institution (e.g., transaction server 142) to obtain data identifying one or more prior activities of a user, to identify a pattern of prior activity within the obtained data, and to identify a preemptive action that, if taken by a user, would avert a potential deviation from the identified pattern.

In one embodiment, transaction server 142 may determine in step 502 whether the user is eligible to receive notifications of deviations from patterns of prior user activity (i.e., the user “opted-in” to receive notifications from the financial institution). For example, transaction server 142 may access data associated with the user (e.g., customer data 144A), and may determine based on the obtained data whether the user elects to receive notifications from the financial institution.

If transaction server 142 finds the user ineligible to receive notifications from the financial institution, transaction server 142 may generate a message that invites the user to “opt-in” to the notification program provided by the financial institution (e.g., step 504). In step 506, transaction server 142 may execute software processes to transmit the generate message to a client device of the user (e.g., client device 102) using one or more of the communications protocols described herein. Method 500 may proceed to step 508.

If, however, transaction server 142 determines in step 502 that the user is eligible to receive notifications from the financial institution, transaction server 142 may obtain data identifying one or more prior activities of a user in step 510. In one embodiment, and as described herein, the obtained data can be communicated over communication network 120 from client devices 102, 104, and 106, and/or can be obtained from merchant system 150. In another embodiment, financial transaction system 140 can obtain data from one or more social network sites such as FaceBook™, Twitter™, Instagram™, etc. In yet another embodiment, financial transaction system 140 may be configured to obtain data from one or more groups of entities, similar to that described above in connection with FIG. 4.

In an embodiment, the data obtained by transaction server 142 in step 510 may identify one or more prior purchases of one or more goods and services by the user (e.g., a purchase of coffee every weekday at or around 10:00 a.m. from a coffee shop), one or more prior financial services transactions associated with an account of the user at a corresponding financial institution (e.g., an electronic fund transfer (EFT) transaction, a deposit of funds, a withdrawal of funds, an online bill payment transaction, and a purchase or sale of securities), and additionally or alternatively, one or more events caused, scheduled, or configured by the user (e.g., a scheduled activation of a coffee maker at or around 7:00 a.m. each day, activation of a home, business, or automobile security system, or a client appointment). The disclosed embodiments are not limited to such exemplary prior activities, and in additional embodiments, the data obtained in step 510 may identify any purchase, financial services transaction, or event that is “trackable” by transaction server 142, merchant server 152, client devices 102, 104, and 106, or any component thereof.

In step 512, transaction server 142 may process the obtained data to derive patterns associated with the user's prior purchases, financial services transactions, and events. As described above, the derived patterns may indicate a sequential relationship between corresponding purchases, financial services transactions, and events (e.g., the user may purchase fuel from a specific filling station after purchasing goods from a specific grocery store), and additionally or alternatively, the derived patterns may correspond to a repetition of a specific purchase, financial services transaction, or event at specific intervals (e.g., the execution of an EFT transaction between a user's checking account and user's credit account on the fifteenth day of each month at or around 5:00 p.m.). The disclosed embodiments are, however, not limited to such exemplary patterns of prior user activity, and in further embodiments, transaction server 142 may identify any additional pattern of user activity in step 512 that is appropriate to the obtained data without departing from the spirit or scope of the disclosed embodiments.

Transaction server 142 may then inspect the derived patterns, and in conjunction with the obtained data, identify a potential deviation from the derived patterns in step 514. In step 516, transaction server 142 may identify a preemptive action that, if taken by the user, would avert the potential deviation. In some embodiments, the potential deviation may represent a non-occurrence of an expected purchase, financial service transaction, or user-scheduled and/or user-configured event, and the preemptive active may represent an action, that when taken by the user, would ensure the occurrence of the expected purchase, financial service transaction, or user-scheduled and/or user-configured event.

By way of example, transaction server 142 may determine in step 512 that the user transfers funds from a checking account at a financial institution (e.g., the financial institution associated with transaction server 142) to a corresponding account associated with a credit card issued by the financial institution on the 28^{th} day of each month (e.g., to satisfy a minimum payment due associated with the credit card). In step 514, transaction server 142 may determine that a failure to request the transfer of funds from the user's checking account to the user's credit card account by 12:00 a.m. on August 28^{th} may represent a “potential” deviation from the derived patterns of prior financial services transactions. Transaction server 142 may determine in step 516 that a request to execute the funds transfer from the user's checking account to the user's credit card account, and additionally or alternatively, the user's enrollment in an automated payment program of the financial institution, represent preemptive actions that would avert the potential deviation.

The disclosed embodiments are, however, not limited to such exemplary deviations and preemptive actions, and in additional embodiments, transaction server 142 may identify any additional or alternate deviation and corresponding preemptive action appropriate to the derived patterns of prior purchases, financial service transactions, or user-scheduled and/or user-configured events. For example, in step 514, transaction server 142 may identify a potential deviation corresponding to an expiration of one or more rewards points offered to the user by the financial institution of a retailer associated with merchant system 150. In such embodiments, transaction server 142 may, in conjunction with merchant server 152, identify one or more transactions for which the rewards points may be redeemed as preemptive actions in step 516.

Referring back to AG. 5, transaction server 142 may generate a message in step 518 that notifies the user of the potential deviation and provides the user with information identifying one or more of the preemptive actions that could avert the potential deviation. For example, as described above, the notification message may alert the user of the failure to schedule the transfer of funds between the checking and credit card accounts, and provide the user with information (e.g., a hyperlink, etc.) that enables the scheduling of the transfer of funds, and additionally or alternatively, the user's enrollment in an automatic payment program provided by the financial institution. Additionally or alternatively, the message generated by transaction server 142 may identify the potential expiration of one or more rewards points, and may identify one or more transactions that, if executed by the user, would enable the user to redeem the points prior to expiration (e.g., through a hyperlink to a retailer offering specific goods and services to which the expiring rewards points may be applicable).

In step 520, transaction server 142 may execute software processing to transmit the message across network 120 to client device 102 using any of the communications protocols outlined above, In some embodiments, transaction server 142 may access data associated with the user (e.g., customer data 144A) to identify a preferred mode of communication with client device 102 (e.g., contact via email or contact via SMS or MMS text message), and transaction server 142 may select a communication protocol that corresponds to the user's preferred mode of communication. Exemplary method 400 may proceed to step 508.

Upon receipt of the message, client device 102 may generate and render the received message for display to the user on a corresponding interface on a display device of client device 102. For example, the rendered message may alert the user of the upcoming payment deadline for the credit card account, notify the user of his or her failure to schedule the transfer of funds between the checking and credit card accounts, and provide the user with a hyperlink to schedule the required payment, or alternatively, enroll in an automatic payment program provided by the financial institution. Upon selection of the hyperlink (e.g., by establishing contact between a stylus or finger and a surface of the display device, by clicking on the hyperlink using a mouse, or by entering one or more keystrokes), client device 102 may execute a web browser that displays a web page associated with the financial institution to the user.

In the embodiments described above, reference is made to techniques that identify patterns of prior user purchases, financial services transactions, and user-configured and/or user-specified events. The disclosed embodiments are not limited to such exemplary user activities and patterns, and in further embodiments, the disclosed techniques may be leveraged by transaction server 142 to identify patterns within any additional or alternate type of activity appropriate to the user and trackable by transaction server 142. By way of example, the user may be a member of a fitness center, and upon checking into the fitness center, a corresponding server (e.g., server 160 or server 152) may transmit information identifying the user, a check-in time, and further, information identifying one or more classes for which the user is registered to transaction server 142.

In one embodiment, an user may check into the fitness center every Monday for a spinning class at 7:30 p.m., and a server associated with the fitness center (e.g., server 160 or merchant server 152) may transmit data indicating the user's arrival to transaction server 142, which may store the received data in a data repository (e.g., customer data 144A). Transaction server 142 may identify a deviation from the user's pattern of prior activity when the received data fails to indicate the user's attendance at the spinning class. In such an embodiment, transaction server 142 may also generate a notification that reminds the user of the schedule spinning class, and additionally or alternatively, provides the user with information identifying other classes offered by the fitness center or a coupon for another spinning class to entice the user to return to the fitness center. Further, the notification may also provide the user with an opportunity to reschedule the spinning class from Monday to Tuesday as a preemptive action that averts the identified deviation.

In additional embodiments, an employee may register an arrival to a place of employment each day 7:00 a.m. (i.e., the user “clocks in” at 7:00 a.m.), and a server associated with the employer (e.g., server 160 or merchant server 152) may transmit data indicating the employee's registered arrival to transaction server 142, which may store the received data in a data repository (e.g., customer data 144A). In such an embodiment, transaction server 142 may identify a deviation from the employee's established arrival pattern, and transaction server 142 may transmit a message to the employer and/or the employee that identifies the employee's failure to arrive at the place of employment. Further, transaction server 142 may identify that the use of sick or annual leave represents a preemptive event that could avert the deviation, and the notification message provided to the employee by transaction server 142 may include a hyperlink that enables the employee to request leave from a human resources department associated with the employer.

Further, in some embodiments, a patient may refill a prescription at a pharmacy at regular intervals (e.g., on a weekly, monthly, or quarterly basis). A server associated with the pharmacy (e.g., server 160 or merchant server 152) may transmit data identifying the requested refill to transaction server 142, which may store the received data in a data repository (e.g., customer data 144A). In such an embodiment, transaction server 142 may be configured to identify a deviation from the patient's refill pattern, and transaction server 142 may then transmit a message alerting the patient to the prior refill schedule and the deviation from that schedule. In another aspect, consistent with the exemplary embodiments described above, the notification provided to the patient by transaction server 142 may include a hyperlink (or other type of message) that reminds the patient or enables the patient to request an immediate refill of the prescription. In other embodiments, transaction server 142 may be configured to execute software instructions that automatically generate and transmit a message to the pharmacy to refill the prescription, or to a physician to request a new prescription (e.g., when the existing prescription has expired).

The disclosed embodiments may also be applied in investment scenarios. For example, transaction server 142 may be associated with an investment system that may be used by a user who is an investor and/or is a financial advisor that uses the processes to administer an actual investment portfolio associated with the investor. By way of example, transaction server 142 may monitor a payment of dividends by issuers of one or more securities held in an actual investment portfolio, and may establish that an issuer of a particular security pays a divided of five centers per share every quarter, Transaction server 142 may monitor to payment of dividends by the particular security, and may identify the issuer's failure to pay the expected dividend during one quarter (e.g., a deviation from the established pattern of divided payment). In such an embodiment, transaction server 142 may provide the investor with a notification that the issuer of the particular security failed to pay the expected dividend, and additionally or alternatively, with information identifying a number of additional securities that conform to a risk tolerance of the investor and whose issues pay the expected dividend.

Additionally, transaction server 142 may monitor the investor's habits regarding portfolio rebalancing, and may determine that the investor rebalances his or her portfolio on alternating Monday mornings. In such an embodiment, transaction server 142 may monitor the investor's activities. Based on the monitored activities, transaction server 142 may determine that the investor failed to rebalance the investment portfolio at a designated time. In response, transaction server 142 may generate and provide to the investor, and additionally or alternatively, a financial advisor associated with the investor, a notification message that the investor failed to rebalance the investment portfolio at the designated time.

While the disclosed embodiments have been described in connection with the transactions, events, and/or purchases of a single user, the disclosed embodiments are not so limited. In additional embodiments, the derivation of such patterns may be based on the purchases, financial transaction, and scheduled and/or configured events associated with a group of users, such as a “peer group” of additional users that are demographically similar to the user. For example, transaction server 142 may be configured to accept input from one or more users that associated a group of users as a peer group having corresponding profile data (e.g., customer data 144A). In one aspect, the profile data may include, but is not limited to, information identifying one or more additional users listed within an email or telephone contact list of the user, information identifying friends of the user within corresponding social networking applications (e.g., Facebook™ and LinkedIn™), and information identifying one or more followers of the user within a micro-blogging application (e.g., Twitter™).

In some embodiments, transaction server 142 may determine a peer group based on, for example, one or more demographic characteristics of the user (e.g., age, income, and education level), the user's location, and one or more user preferences specified within corresponding user profile data (e.g., customer data 144A). Additionally or alternatively, the peer group may include users who share an investment risk tolerance, users that share one or more transaction characteristics (e.g., purchases from common retailer, purchases of common goods or services), or who have a similar history of financial services transactions (e.g., users that day trade in speculative securities). In such embodiments, transaction server 142 may access profile data for a first user in the peer group, may select one or more additional users associated with the financial institution for inclusion in the peer group, and may subsequently identify transaction data associated with not only the user, but also with the peer group of users.

Further, in some embodiments, transaction server 142 may identify a deviation from patterns of prior purchases of a first user, and may transmit a notification of the identified deviation to each member of the user's peer group, including the first user. For example, transaction server 142 may generate the notification of the deviation (e.g., step 420 or step 518), and transmit the generated notification to the user via client device 102, and to client devices associated with each of the other members of the user's peer group (e.g., client devices 104 and 106).

Certain disclosed embodiments are described herein with reference to the accompanying drawings. The disclosed embodiments, however, are not limited to [symbol] 7:00 a.m. and 8:00 a.m.). A transaction may also include activities relating to a physical item, such as a package, a vehicle, a good, etc. The disclosed embodiments perform processes that may collect information associated with such transactions, analyze the collected information, and automatically identify a transaction pattern based on the analysis. The disclosed embodiments may analyze the identified transaction pattern to predict when an event should occur based on the identified transaction pattern, and also monitor for that event. The disclosed embodiments may determine a negative event when the predicted event does not occur in accordance with the identified transaction pattern. The disclosed embodiments may also automatically generate and provide a negative event notification reflecting the absence of the predicted event. The disclosed embodiments may also automatically determine whether or not to generate and provide a negative event notification based on user or preconfigured rules.

In certain aspects, the disclosed embodiments may link a monitored event to a physical real-world event and non-financial transactions. For example, in certain embodiments, financial transaction system 140 may be a transaction system that is configured to perform processes consistent with the disclosed embodiments for transactions associated with non-financial service activities, such as activities relating to the physical presence of a person and activities relating to a physical item, such as a package, good, smart device (e.g., a home appliance with programmed monitoring and reporting capabilities, security system component, etc.), and any other tangible physical item, which may be configured with event detection, monitoring, and reporting capabilities.

In one example, a transaction system configured consistent with the description of financial transaction system 140 may execute software processes that collects transaction information relating to transactions for a user's geographic location, whether by GPS coordinates, or associated with a particular location (e.g., particular merchant, business, educational facility (e.g., school), place of employment, travel service location (e.g., toll booth), etc.

For instance, a user may be associated with an identification card, badge or similar item (e.g., RFID tag on an identification badge, smart phone with NFC capabilities, etc.) that allows user access to their place of employment. The user's employment location may have a system that reads information from the user's identification card when the user presents it as he or she enters the location (e.g., swipes a card, presents it to an RFID reader, walks through a sensor location, etc.). The system may be configured to identify, collect, store, and send the user's identification information to the transaction system as a transaction. In one embodiment, the information may include the user's name, time stamp information of when the user's identification card was read, location information, and similar data. The transaction system may be configured to collect and store such transactions to for analysis to identify a transaction pattern relating to the user's presence at that location (e.g., when the user shows up for work).

The transaction system may perform the transaction pattern determination processes consistent with the disclosed embodiments to determine a transaction pattern associated with the user's history of showing up to work. Further, the transaction system may be configured to perform the disclosed negative event determination, detection, and/or notification processes to determine when a negative event occurs relating to an absence of the user at work in accordance with the determined transaction pattern, and generate and provide an alert that identifies the negative event. For example, the transaction system may generate and provide an alert message to the user via email, text message, automated voice message, etc. to the user's client device informing them of negative event. In other aspects, a different user may receive the negative event notification, such as the user's supervisor, or other designed person.

Similar processes are applicable for monitoring the attendance of a user's child at school or other location. For instance, the transaction system may receive transaction information reflecting when a user's child arrives at their school each day. By analyzing the collected transaction information, the transaction system may determine a transaction pattern corresponding to a pattern when the child arrives at the school each day, and to determine a predicted event when the child should arrive in future time periods. The transaction system may perform the disclosed negative event processes to determine when the child does not arrive at the school at the predicted time, and may generate and send a negative event notification to the child's parent in accordance with the disclosed embodiments. Similar processes may be applicable for when a user or the user's child does not use an expected form of transportation based on determined transaction patterns. For instance, the transaction system may be configured to allow the parent to configure rules to allow the parent to receive a negative event notification when the parent's child does not use a school bus or other form of transportation (e.g., public transportation, etc.). In such embodiments, the reporting location or system is configured with infrastructure and processes that allow the presence of the child (or user) to be monitored and reported (e.g., electronic bus or train passes, etc.).

In other embodiments, the disclosed embodiments may allow a user to configure and modify one or more rules that control when a negative event notification should occur. For example, a transaction system consistent with the financial transaction system 140 may be configured to generate and provide user-interfaces that allow the user to delay or prevent a negative event notification from being provided, even when the transaction system determines that such an event occurs.

In one example, a user may access the transaction system over a network (e.g., network 120), log-on to a user account using password or similar security mechanisms, and configure a negative event notification based on certain types of transactions. For instance, the transaction system may determine that the user purchases coffee from a particular Starbucks™ location (or cations) everyday between 7:00 a.m. and 7:15 a.m. The user, however, may configure a negative event notification rule through the transaction system such that the transaction system does not provide a negative event notification until 7:30 a.m. (e.g., transaction system delays the generation and provision of a negative event notification until it determines that the user did not purchase coffee at the identified Starbucks™ locations by 7:30 a.m.). Similar configurations may apply to other types of transactions and negative events, consistent with the disclosed embodiments and examples provided herein.

In other embodiments, the transaction system may be configured to accept input from a user that modifies determined transaction patterns, which may delay or prevent a negative event notification to occur. In one aspect, the user may view a transaction pattern identified and provided by the transaction system to the user (e.g., via the user's client device) and modify the pattern, Following the above example, the transaction system may allow the user to select and change the identified pattern from purchasing coffee between 7:00 a.m. to 7:15 a.m. to a new time range, such as 7:00 a.m. to 7:30 a.m. In addition, or alternatively, the user may be able to select and change the identified transaction patter based on the merchant location (e.g., remove the Starbucks™ parameter of the identified pattern or add a new or additional coffee merchant).

In one embodiment, the transaction system may be configured to determine different types of deviations that may delay or prevent the transaction system from providing a negative event notification. In one embodiment, transaction system may be configured to analyze collected transaction information consistent with the above disclosed processes, and determine patterned deviations or non-patterned deviations. A patterned deviation may include an expected deviation from a determined transaction pattern based on a pattern of nonoccurrences of the expected transaction consistent with the identified transaction pattern. Non-limiting examples of a patterned deviation may include transactions that occur on a weekend (e.g., Saturday and Sunday), which may deviate from expected transaction patterns that occur during the work week (e.g., Monday through Friday), or during identified holidays, such as a federal holiday (e.g., New Years Day). A non-patterned deviation may include a temporary expected deviation from the determined transaction pattern based on information associated with an identified schedule of one or more temporary events associated with the user. Non-limiting examples of a non-patterned deviation may include transactions that occur while a user is on a scheduled vacation, which may deviate from expected transaction patterns.

As an example, the transaction system may be configured to execute software instructions that perform processes that determine, based on the collected transactions, patterned deviations from the timestamp information that may be included in the transaction information provided to the transaction system. Thus, following the above example relating to coffee purchases, the transaction system may determine that the user's transactions that occur during a weekend that deviate from the expected transaction pattern (e.g., the user purchases coffee at 9:00 AM on a Saturday) do not initiate a negative event notification. Similarly, the transaction system may be configured to execute software instructions that perform processes to determine whether a transaction that deviated from an expected transaction pattern occurred while the user was on a scheduled vacation or work travel. In certain embodiments, the transaction system may be configured to, with permission from the user, to access an electronic calendar to determine whether a detected negative event occurs or is related to a transaction that occurs during the time period when the user is scheduled to be on vacation, work travel, or other activities that warrant the deviation.

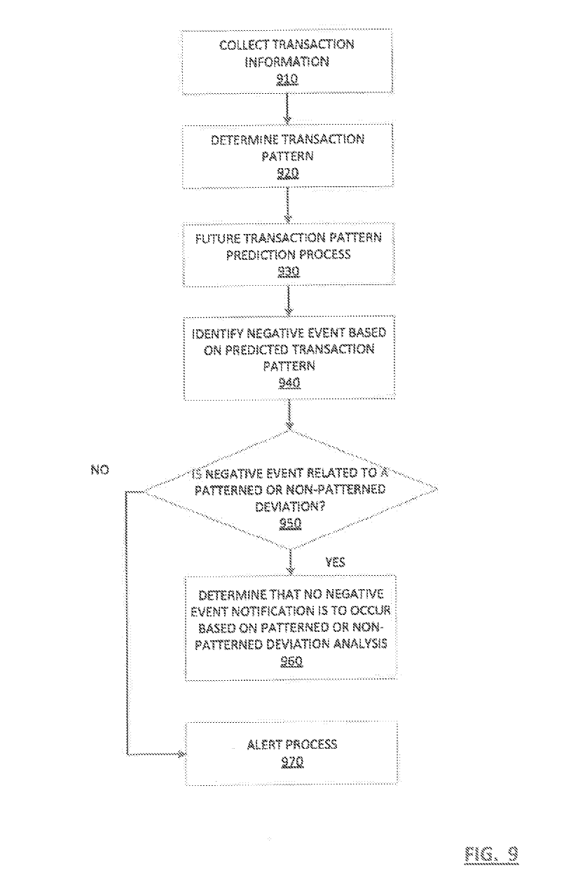

In one embodiment, the transaction system may provide mechanisms (e.g., via an online portal or similar) that enable the user to inform the transaction system negative event notification processes of such temporary travel arrangements. In such instances, the transaction system may execute software instructions that perform processes that consider the user's travel schedule to determine whether to generate and provide a negative event notification. These aspects may be performed using processes consistent with the disclosed embodiments, such as those disclosed above in connection with FIG. 4, FIG. 9 shows a flowchart of an exemplary negative event notification process consistent with these and other disclosed embodiments, such as those disclosed above in connection with FIG. 4. In certain aspects, the anticipated deviation of FIG. 4, may be associated with a patterned or non-patterned deviation.

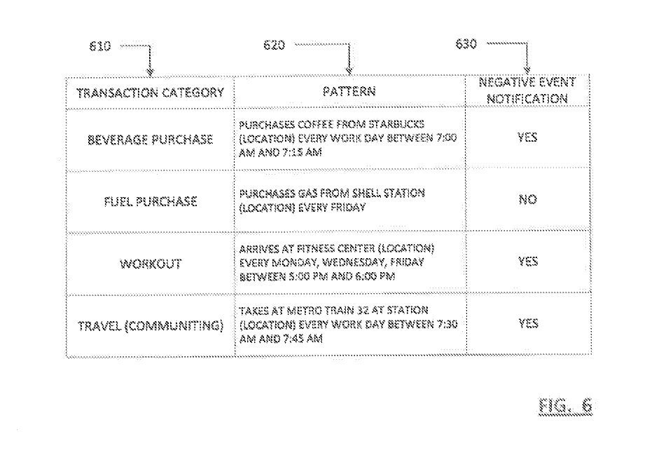

The disclosed embodiments also provide mechanisms to determine and present transaction patterns for review by one or more users. Additionally, the disclosed embodiments also include systems and processes for providing mechanisms to enable a user to view determined transaction patterns for the user or a different user or users, and to configure and modify negative event notifications. For example, FIG. 6 shows an exemplary diagram of an exemplary data structure that may be generated and provided for display (in the same or different formats) on a user's client device. In this example, the transaction system may generate and provide the data structure to present to the user one or more determined transaction patterns. In one aspect, the transaction pattern data structure may include one or more entries identifying for one or more of the determined transaction patterns, a transaction category (e.g., 610), such as a beverage purchase, fuel purchase, workout activity, and travel. Other types of categories may be used, and the disclosed embodiments are not limited to the examples shown in FIG. 6. In addition, the transaction system may provide information describing the transaction pattern for the corresponding transaction category (e.g., 620). In another embodiment, the transaction system may provide information that identifies whether a negative event notification will occur if the system identifies a deviation from the transaction pattern listed in the data structure (e.g., 630).

The transaction system may generate content and information that is provided to the user's client device for display on a user-interface such that the user can view the types and details of one or more of the transaction patterns for the user. In the example of FIG. 6, the user may be able to view that he or she has certain patterns relating to financial transactions (e.g., beverage purchases and fuel purchases) and/or other types of transactions, such as travel or workout patterns. In one embodiment, the transaction system may integrate the use of the data structure displayed to the user such that the user can configure the negative event notification process consistent with the exemplary embodiments disclosed above. For example, in one aspect, the user may be able to select the negative event notification field for a certain transaction pattern (e.g., beverage purchase) to turn on or off the negative event notification. In another embodiment, the user may be able to select the pattern description (e.g., 620) to edit the parameters of the pattern (e.g., change the time period for the beverage purchase transaction pattern from 7:00 a.m. to 7:15 a.m. to 7:00 a.m. to 7:30 a.m.).

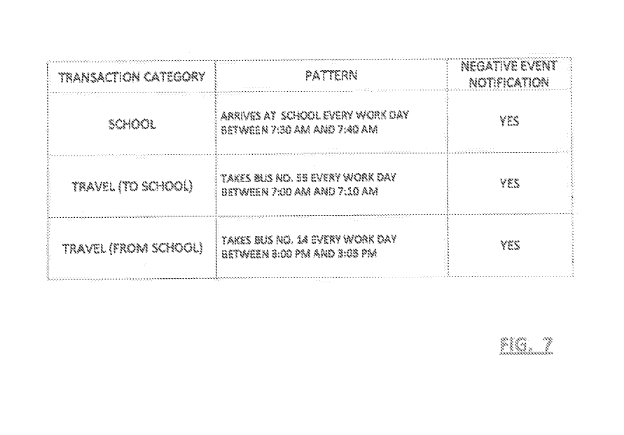

As explained, the disclosed embodiments include methods and systems that allow negative event notifications to be generated and provided to a user for transactions relating to a person other than the user. As such, the aspects relating to FIG. 6 may also be applicable to such embodiments. For example, FIG. 7 shows an exemplary diagram of an exemplary data structure that may be generated and provided for display (in the same or different formats) on a user's client device relating to the transaction patterns of a person other than the user who receives negative event notifications. In the exemplary data structure of FIG. 7, the patterns may relate to transactions of a child of the user, such as arriving at school and/or travel to or from school on identified buses. Like that disclosed above for FIG. 6, the transaction system may allow the user (e.g., a parent) to configure the transaction pattern and negative event notification parameters to control how negative events may be reported to the user or other person(s).

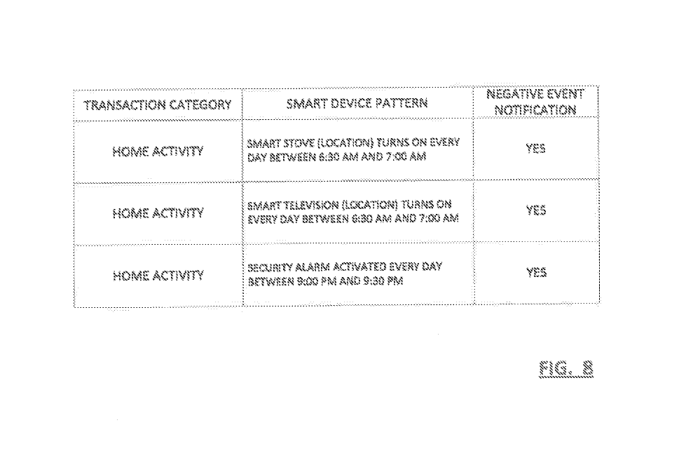

FIG. 8 shows another block diagram of an exemplary data structure similar to those of FIGS. 6 and 7, but relating to transactions of a physical item. In this example, the data structure of FIG. 8 may include transaction pattern information for one or more smart devices located in the residence of a user or a person different from the user (e.g., an elderly relative of the user). Like that disclosed above for FIGS. 6 and 7, the transaction system may allow the user to configure the transaction pattern and negative event notification parameters to control how negative events may be reported to the user, or to other person(s).

Other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. A computer-implemented method for determining negative events, comprising:
collecting, by one or more processors, prior transaction information associated with a user, the prior transaction information identifying one or more prior transactions;
determining, by the one or more processors, a transaction pattern based on the collected transaction information;
determining, by the one or more processors, a negative event reflecting a deviation from the transaction pattern, the deviation being a nonoccurrence of an expected transaction consistent with the transaction pattern; and
providing, by the one or more processors, a negative event notification that identifies the deviation.

2. The method of claim 1, wherein determining the negative event comprises identifying the expected transaction based on the transaction pattern and prior transaction information.

3. The method of claim 1, wherein the expected transaction is associated with an expected transaction time, and wherein the determining the negative event comprises determining whether the expected transaction occurs within a threshold time period of the expected transaction time.

4. The method of claim 1, further comprising:
determining whether the deviation corresponds to an anticipated deviation; and
providing the negative event notification when the deviation fails to correspond to the anticipated deviation.

5. The method of claim 1, wherein:
the one or more prior transactions include prior financial transactions associated with the user; and
at least one of the prior financial transactions includes at least one of a purchase of a good or service by the user, a fund transfer, a bill payment, a purchase of a financial instrument, a sale of a financial instrument, a deposit of funds, a withdrawal of funds, or an application for credit.

6. The method of claim 1, wherein providing the negative event notification includes providing the negative event notification to at least one of the user and a second user different from the first user.

7. The method of claim 1, wherein providing the negative event notification includes providing the negative event notification in an electronic mail message, a text message, an automated voice message, or as content on a web page that is accessible over a network.

8. The method of claim 1, further comprising receiving a user-defined threshold time period, and wherein determining the negative event comprises determining whether the expected transaction occurs within the user-defined threshold time period of the expected transaction time.

9. The method of claim 1, further comprising:
determining whether the determined negative event corresponds to a patterned deviation or a non-patterned deviation; and
preventing the negative event notification from being provided based on the determination that the determined negative event corresponds to the patterned deviation or the non-patterned deviation.

10. The method of claim 9, wherein the patterned deviation includes an expected deviation from the determined transaction pattern based on a pattern of nonoccurrences of the expected transaction consistent with the transaction pattern, and wherein the non-patterned deviation includes a temporary expected deviation from the determined transaction pattern based on information associated with an identified schedule of one or more temporary events associated with the user.

11. A system for determining negative events, comprising:
a storage device; and
at least one processor coupled to the storage device, the storage device storing software instructions for controlling the at least one processor when executed by the at least one processor, and the at least one processor is operative with the software instructions and is configured to:
collect prior transaction information associated with a user, the prior transaction information identifying one or more prior transactions;
determine a transaction pattern based on the collected transaction information;
determine a negative event reflecting a deviation from the transaction pattern, the deviation being a nonoccurrence of an expected transaction consistent with the transaction pattern; and
provide a negative event notification that identifies the deviation.

12. The system of claim 11, wherein the one or more processors are configured to determine the negative event by identifying the expected transaction based on the transaction pattern and prior transaction information.

13. The system of claim 11, wherein the expected transaction is associated with an expected transaction time, and wherein the one or more processors determine the negative event by determining whether the expected transaction occurs within a threshold time period of the expected transaction time.

14. The system of claim 11, wherein the one or more processors are configured to determine whether the deviation corresponds to an anticipated deviation, and provide the negative event notification when the deviation fails to correspond to the anticipated deviation.

15. The system of claim 11, wherein:
the one or more prior transactions include prior financial transactions associated with the user; and
at least one of the prior financial transactions includes at least one of a purchase of a good or service by the user, a fund transfer, a bill payment, a purchase of a financial instrument, a sale of a financial instrument, a deposit of funds, a withdrawal of funds, or an application for credit.

16. The system of claim 11, wherein the one or more processors are configured to provide the negative event notification to at least one of the user and a second user different from the first user.

17. The system of claim 11, wherein the one or more processors are configured to provide the negative event notification in an electronic mail message, a text message, an automated voice message, or as content on a web page that is accessible over a network.

18. The system of claim 11, wherein the one or more processors are configured to receive a user-defined threshold time period, and determine the negative event by determining whether the expected transaction occurs within the user-defined threshold time period of the expected transaction time.

19. The system of claim 11, wherein:
the one or more processors are configured to determine whether the determined negative event corresponds to a patterned deviation or a non-patterned deviation, and prevent the negative event notification from being provided based on the determination that the determined negative event corresponds to the patterned deviation or the non-patterned deviation;
the patterned deviation includes an expected deviation from the determined transaction pattern based on a pattern of nonoccurrences of the expected transaction consistent with the transaction pattern; and
the non-patterned deviation includes a temporary expected deviation from the determined transaction pattern based on information associated with an identified schedule of one or more temporary events associated with the user.

20. A tangible, non-transitory computer-readable medium storing instructions that, when executed by at least one processor, cause the at least one processor to perform a method, comprising:
collecting prior transaction information associated with a user, the prior transaction information identifying one or ore prior transactions;
determining a transaction pattern based on the collected transaction information;
determining, by the one or more processors, a negative event reflecting a deviation from the transaction pattern, the deviation being a nonoccurrence of an expected transaction consistent with the transaction pattern; and
providing a negative event notification that identifies the deviation.
